(19) United States
(12) Patent Application Publication
(10) Pub. No.: US 2004/0094341 A1
(43) Pub. Date: May 20, 2004

(54) Hybrid electric vehicle using micro-thrust engines

(76) Inventors: Kari Appa, Lake Forest, CA (US); Suri Narayan Appa, Lake Forest, CA (US)

Correspondence Address: Dr. Kari Appa, 22242 Anthony Drive, Lake Forest, CA, 92630-2327, US

(21) Appl. No.: 10/294,805

(22) Filed: Nov. 14, 2002

(51) Int. Cl. B60K 1/00

(52) U.S. Cl. 180/65.2

(57) ABSTRACT

The present invention relates generally to the design of a novel hybrid electric vehicle and, more particularly, to a method of using micro-thrust engines to produce electrical power by fuel-efficient means. A combination of a deep cycle battery and micro-thrust engines powered generator system are used to provide needed propulsion power. Water/steam is used to cool the combustion chamber of said engines thereby regeneratively extracting heat of rejection to super heat the steam. The super heated steam is further injected into the combustion chamber to extract additional energy. Thus, in normal driving conditions, power is drawn from the battery, while during acceleration and uphill driving, steam is used instead of fuel thereby economizing on fuel consumption.

### BACKGROUND OF THE INVENTION

1. Field of the Invention

The present invention relates generally to the design of a novel hybrid electric vehicle and, more particularly, to a method of using micro-thrust engines to produce electrical power by economical means.

2. Description of Prior Art

Most hybrid electric vehicles use either the fuel cells or on-board battery charging systems. The fuel cell technology uses hydrogen and oxygen to produce electricity that powers a traction motor drivingly connected to a pair of wheels of a vehicle. From the practical viewpoint, it is difficult to store sufficient volume of hydrogen in a manageably sized container. Hence, recent fuel cell technologies are being developed to generate hydrogen on-board by reforming commonly used fossil fuels. This technology is still in the development stage and hence is not yet cost effective for commercialization.

An alternate hybrid approach is to use/either a small internal combustion or a gas turbine engine to drive a generator at constant speed and charge a deep cycle battery system. The battery source is then used to power said traction motor. Since a very small engine is required to drive a generator, the fuel consumption could drastically be reduced.

A number of patents are typical of the known prior art attempting to improve on earlier efforts to develop viable pollution-free hybrid vehicles. For example U.S. Pat. Nos. 5,772,707 and 5,989,503 to Wiesheu et. al. disclose a “Process and Apparatus for Methanol Reforming.” This method describes a method of producing hydrogen fuel in a vehicle that can be used in an electric vehicle fuel cell. U.S. Pat. No. 4,438,342 to Kenyon describes a “Novel Hybrid Electric Vehicle,” in which a quick surge of power can be delivered to the load to achieve rapid acceleration of a vehicle. Another U.S. Pat. No. 6,367,570 to Long, et. al. describes a “Hybrid Electric Vehicle with electric motor providing strategic power assistance to load and balance internal combustion engine.” Here, an electric motor strategically assists an internal combustion engine. Decreased emissions are realized by helping the engine to run in a fashion, which inherently minimizes emissions. U.S. Pat. No. 6,380,653 B1 to Masahiro describes a method of “Rotational Power Converter for Hybrid Electric Vehicle.” It is composed of a stator fixed to a cylinder housing and a first rotor and a second rotor rotatably supported in the housing. The first rotor is driven by an internal combustion engine, and the electric power is supplied to the stator from a battery, forming a rotating magnetic field in the stator. Rotational power is electromagnetically transferred from the first rotor to the second rotor that is connected to the driving wheels.

The mathematician and inventor Hero, who is believed to have lived in Alexandria between 150 BC and 50 AD, disclosed the earliest steam jet powered mechanical device. His writings, in Greek, concern the studies of mechanics and pneumatics. They include nearly 80 ingenious inventions such as siphons, fountains, and engines.

The first jet assisted rotor technology for a helicopter design was introduced by Friedrich von Doblhoff in 1940. Later Hiller used this idea to build crane helicopters for US military. U.S. Pat. No. 5,660,038 to Stone discloses a power generating rotary jet engine that uses at least one combustion jet mounted on a circular disk. U.S. Pat. No. 6,127,739 issued to Appa discloses a jet assisted contra rotating wind turbine system designed to enhance power conversion efficiency utilizing blade tip mounted jet thrusters and counter rotation of tandem rotors.

U.S. Pat. No. 6,213,234 B1 to Rosen and Willis discloses a vehicle powered by a combination of fuel cell and a gas turbine. Up to 50 percent of needed power could be drawn from the fuel cell. U.S. Pat. Nos. 6,223,521, 6,233,918 and 6,263,660 B1 to Lawlor disclose a method of generating utility scale power system using ramjets mounted at the periphery of a disc that spins at supersonic speeds. The thermodynamic advantage is achieved by the ram-compression of the inlet air-fuel mixture.

It was with the knowledge of the foregoing state of the technology that the present invention has been conceived and is now reduced to practice. Furthermore, this system can be easily retrofitted in existing electric vehicles without significant alterations in the design.

### SUMMARY OF THE INVENTION

The present invention describes a method of designing and manufacturing an environmentally friendly hybrid power system for electric vehicles, that could have satisfactory driving range, speed and acceleration without impacting on desired environmental emission standards. Said apparatus comprises:

1. plurality of hybrid micro-thrust engines mounted at the rim of a spinning disc and produce torque to drive an electrical generator,

2. said generator having a rotor and a stator,

3. a supporting framework having an enclosure that collects exhaust gases and condensed steam for regeneratively recycling steam,

4. said rotor having a hollow shaft that permits a passage for co-axial conduits that convey fuel-air mixture and water/steam,

5. a coaxial rotary coupler to convey fluids from a stationary platform to a rotating frame,

6. a traction motor/generator driveably connected to a vehicle,

7. a pair batteries and power electronics to manage power between the battery source and the, and

8. a control system to manage the dual power system.

The Hybrid Micro-Thrust Engine:

The hybrid micro thrust-engine of the present invention comprises a combustion chamber and a cooling jacket. These two units are fastened to each other at one end, while other end is fitted with a converging-diverging nozzle of the De Laval type. A co-axial conduit device having passages for conveying air-fuel mixture in the inner tube, and water/steam in the outer tube is fitted inside of the hallow shaft of the rotor. A rotary fluid coupling unit is used to convey fuel mixture and steam from a stationary platform to a rotating frame. Compressed air-fuel mixture will be injected into the combustion chamber and ignited so that combustion process is complete according to the stoichiometric proportion and releases maximum heating value of the fuel. After the reaction is over no surplus ingredients will be left. Water (initially) or steam (after several seconds of the combustion process) will be injected into the cooling jacket. For the natural gas as the fuel, the combustion chamber temperature will rise to is 3,600 deg F. or 1982 deg C. This temperature is too high for any materials in commercial use. In order to reduce the temperature for continuous operation of the engine, water or steam will be circulated in the outer jacket and super heated steam will be injected into the combustion chamber just before the converging section of the De Laval nozzle. To bring the combustion chamber temperature under 1000 deg F., the required steam to fuel ratio is about 20 to 40 to 1 by weight. The addition of steam reduces the fuel consumption by nearly 60 percent. The natural gas primarily consists of 95% methane CH4, while air consists of 80% of nitrogen and 20% of oxygen. The combustion of natural gas and air in stoichiometric proportion yields 11% of steam, 13% of carbon dioxide and 76% of nitrogen. The super heated steam condenses while expanding through the diverging nozzle. This steam can be pumped back to the steam jacket to cool the combustion chamber and maintain its temperature at structurally safe level. The other bi-products, CO2 and N2 could also be collected and recycled for industrial use. Nitrogen can be used in fertilizer factories or saved as liquid nitrogen for many other commercial applications.

It is intriguing to note that the liquid nitrogen at ambient temperature could expand to 700 fold by volume or could be stored at high pressure. Consequently, it could also be used as a working fluid in the nozzle to generate thrust. Thus, the natural gas is seen to be an environmentally friendly fuel source for power generation and transportation.

Power Generation:

Plurality of said engines are fixed on the periphery of a disc. Said disc and the rotor of an electrical generator are firmly fixed to a co-axial shaft. Said co-axial shaft is rotatably mounted on a supporting framework. An electrical armature having constant air gap around the said rotor is firmly mounted on the said framework. Pre-mixed and compressed fuel is conveyed to the combustion chamber through an inner conduit, while water/steam is conveyed to the cooling jacket through the outer conduit. At stoichiometric proportion of air and fuel, the combustion chamber temperature rises to 3600 deg. F. This temperature will be reduced by injecting some steam into the combustion chamber. The velocity ratio of the exhaust gas Vₑ and the peripheral speed of said engine must be maintained at one for optimum efficiency of the engine. Thus, said engines drive the generator to produce electrical energy and store in said batteries. In normal driving conditions, the battery power alone will be used to propel the vehicle. In accelerated and/or uphill driving conditions both the battery and the generator power will be used to meet the demand.

For normal driving conditions, the aerodynamic drag and rolling friction components will be used to calculate the battery power capacity and the fuel performance characteristics of a vehicle. The power demand in accelerated driving conditions will be met by both the battery source and the generator. Additional steam instead of fuel will be used to output momentary surge of power from the generator.

Other features and benefits of the invention will become apparent in the following description taken in conjunction with the following drawings. It is to be understood that the foregoing general description and the following detailed description are exemplary and explanatory but are not to be restrictive of the invention. The accompanying drawings which are incorporated in and constitute a part of this invention, illustrate one of the embodiments of the invention, and together with the description, serve to explain the principles of the invention in general terms. Like numerals refer to like parts throughout the disclosure.

### BRIEF DESCRIPTION OF THE DRAWINGS

The foregoing aspects and other features of the present invention are explained in the following description, taken in connection with the accompanying drawings, wherein:

1. Title of the Drawings

FIG. 1 is a perspective view of a hybrid electric vehicle

FIG. 2 is a perspective view of a hybrid power system,

FIG. 3 is a perspective view of the micro thruster and nozzles,

FIG. 3a is a dual nozzle system having two De Laval nozzles

FIG. 3b is a dual nozzle system having one De Laval nozzle, and one converging nozzle

FIG. 4 is a block diagram of the power system,

FIG. 5 is a plot of fuel consumption versus vehicle speed for varying amount of steam input,

FIG. 6 is a plot of fuel consumption in miles per pound of fuel versus vehicle speed for varying amount of steam input,

FIG. 7 is a plot of Horse Power and steam input versus vehicle speed,

FIG. 8 is a plot of air input at stoichiometric ratio versus vehicle speed for various amount of steam input

2. Reference Numerals

11 hybrid power system

12 deep cycle batteries

13 electric motor

14 Power connections from generator to motor

15 Power connections from battery to motor

16 Vehicle tires

17 Generator rotor

18 Generator armature

19 inner conduit conveying air-fuel mixture

20 a framework related to transfer of fluids from stationery platform to a moving platform,

21 generator armature framework

22 Co-axial shaft and steam conduit

23 stationary framework assisting fluid flow from a stationary reference frame to a rotating frame,

24 air-fuel mixture input

25 water/steam input

26 a framework that supports the assembly hybrid power system

27 recycling pump

28 cooling grill

29 hybrid micro-thrustengine

30 spinning disc

31 combustion chamber

32 De Laval nozzle

33 Cooling jacket

34 Combustion chamber heat transfer surface exposed to water/steam

35 Steam inlet into the combustion chamber

36 Nozzle base

37 Inner nozzle

38 Outer nozzle

39 co-axial conduits for air-fuel mixture and steam inlet

### DETAILED DESCRIPTION OF THE PREFERRED EMBODIMENT

The novel featured characteristics of this invention are set forth in the appended claims. The invention itself, may be best understood and its objects and advantages best appreciated by reference to the detailed description below in connection with the accompanying drawings. Although the present invention will be described with reference to the embodiment shown in the drawings, it should be understood that the present invention could be embodied in many alternate forms or embodiments. In addition, any suitable size, shape or type of elements or materials could be used.

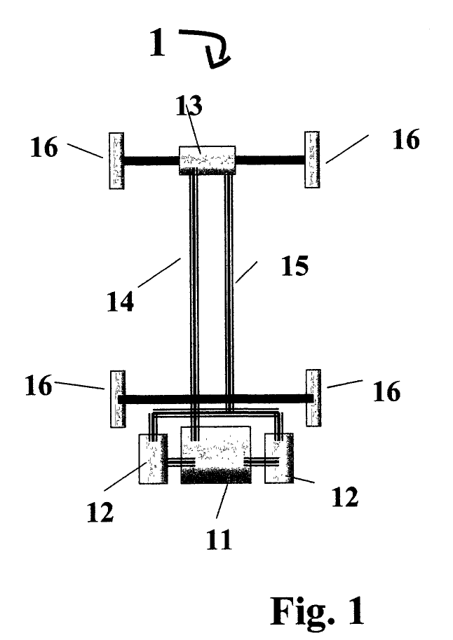

FIG. 1 diagrammatically represents a hybrid electric vehicle 1 comprising a hybrid power system 11, a deep cycle battery system 12, a traction motor 13 driveably connected to low friction tires 16. Said motor is provided with dual power supply cables 14, 15. In normal driving conditions said motor receives power from said battery, while in acceleration and uphill driving conditions the power is derived from both said power systems, namely battery and generator.

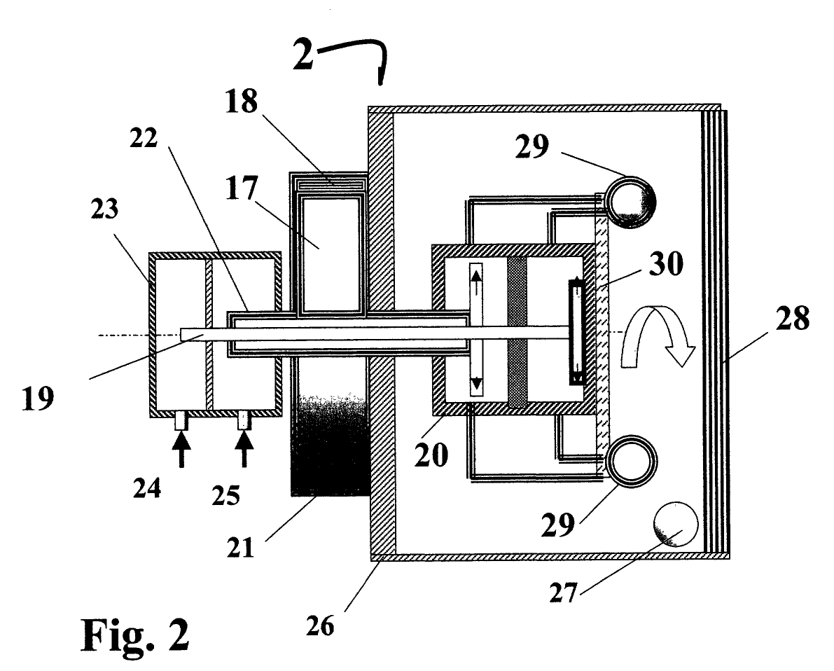

Referring now to FIG. 2, there is shown a cut-away view of said hybrid power system incorporating the features of the present invention. Said hybrid power system primarily consists of a rotating platform 30 rotatably mounted on a supporting framework 26, by means of a coaxial shaft 22 and an electrical generator 21 having an armature 18 firmly fixed to said framework and a rotor 17 firmly fixed to said shaft. Plurality of micro-thrust engines 29 are mounted on the periphery of said platform to generate torque and produce power by means of said generator.

A rotary fluid conveying inlet device 23 is provided on one end of said shaft, and an outlet device 20 is firmly attached at the other end of said shaft. A fluid conveying device 19 is firmly fixed to said shaft. Compressed air and fuel mixture enters said inlet device at inlet 24, while water/steam enters at inlet 25. Pressure sealed bearings (not shown) are used to avoid leakage between air-fuel and steam compartments of said inlet device. Since the outlet device is spinning at a very high angular velocity suction pressure will be created at inlets 24, 25, requiring no additional pumps. Thus, fuel and cooling fluids will be conveyed to said engines in a rotating frame. As high enthalpy gases and vapor expand through the nozzle, the steam vapor condenses. Additional cooling means is provided by the grillwork 28. Said grillwork may also be used to pre-heat the air-fuel mixture before being injected into the combustion chamber.

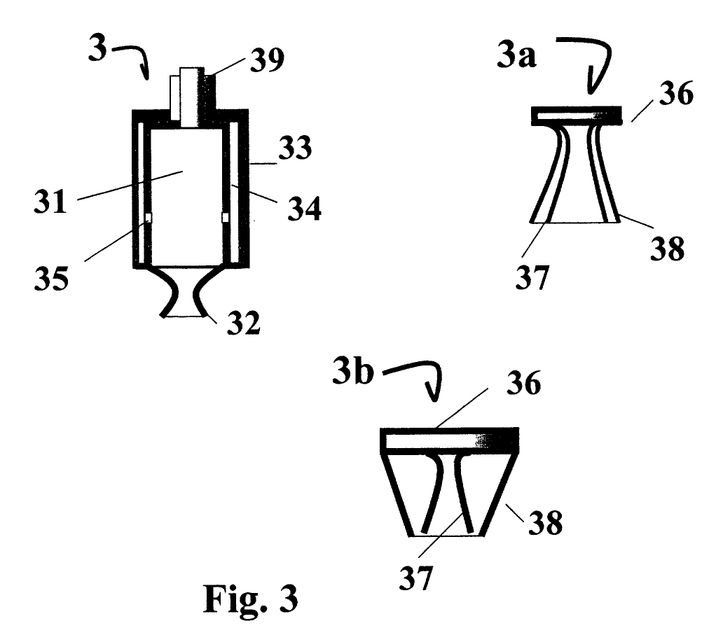

FIG. 3 shows an outline of said micro-thrust engine comprising a combustion chamber 31, a cooling jacket 33, a nozzle 32, and coaxial fluid inlets 39. The air-fuel mixture is injected into said combustion chamber through the inner conduit, while water/steam injected into said jacket through the outer conduit. At stoichiometric air-fuel ratio complete combustion takes place and releases all the thermal energy contained in the fuel.

CH₄+2O₂+N₂ - - - >CO₂+2H₂O+N₂+888kJ/mol (1)

16 kg (methane)+64 kg (oxygen)+256 kg (nitrogen contained in air)→44 kg (Carbon dioxide)+36 kg (steam)+256 kg (nitrogen)+888 kJ/mol (heat)

This energy results in burnt gas temperature of 3600 deg. F. This temperature is too high for continuous operation of the engine. Hence, it is necessary to lower the temperature to around 1000 deg. F. or less by mixing with water or steam. The steam, which was used to cool the combustion chamber, is now super heated, and will be injected tangentially into said combustion chamber at inlet 35. The tangential flow creates a vortex that helps to mix the burnt gases rapidly and uniformly. This mixed fluid at high energy will then be expanded through the De Laval nozzle to generate thrust.

In FIGS. 3a-3b, are seen two alternate co-axial nozzle devices 37, 38, which may be designed to reduce jet noise. Special vortex flow devices can be built into the outer nozzle to generate counter rotating vortex flow pairs in the outer nozzle, which are known to suppress jet noise.

Hybrid Electric Vehicle Performance Analysis:

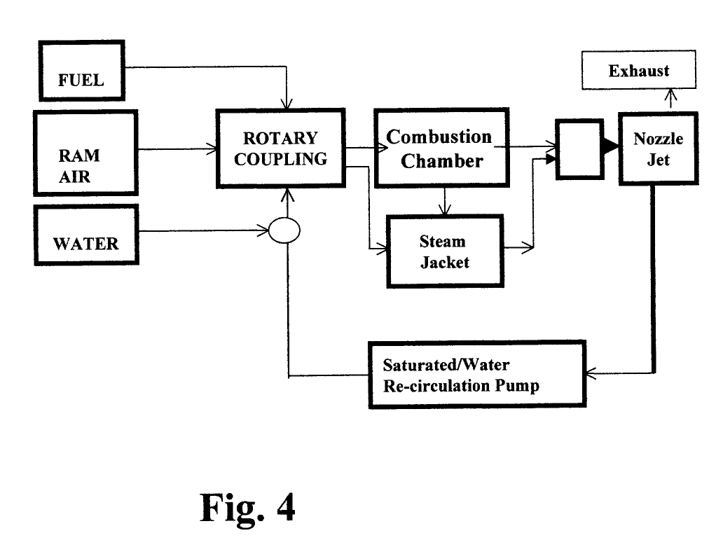

FIG. 4 depicts an overview of the methodology of the present invention. The foregoing discussion briefly outlines a mathematical basis with some examples.

Electric Vehicle Power Requirement:

The power (or rate of work) required to propel a vehicle can be expressed as;

\dot{W}ₜₒₜₐₗ=\dot{W}_{accel}+\dot{W}_{climb}+\dot{W}_{rolling}+\dot{W}_{drag} (2)

where the rate of work for accelerating a body is given by

\dot{W}_{accel}=maV (3)

the rate of work done in climbing an uphill road is given by

\dot{W}_{climb}=mgV sin θ (4)

the rate of work done in overcoming the tire rolling friction is given by

\dot{W}ᵣₒₗₗ=μmgV cos θ (5)

the rate of work done against aerodynamic drag

$${\dot{W}}_{drag} = {C}_{d} {A}_{F} ( \frac{1}{2} ρ {V}^{3} ) \qquad ( 6 )$$

in which

A_{F} vehicle frontal area

C_{d} aerodynamic drag coefficient

m is the mass of the vehicle

V is the vehicle speed

a is the vehicle acceleration

ρ is the air density

μ is the coefficient of tire rolling friction

θ is the gradient of the road

Generation of Electrical Power

An electric motor is used to provide the propulsion means to the vehicle. The desired rate of energy will be provided by an electric generator, powered by plurality of micro-thrusters. The thrust of a micro-jet is given by

T=qVⱼ (7)

where, q is the mass flow rate of exhaust gases and Vⱼ is the exhaust gas velocity, which is given by,

Vⱼ=[2*g*J*Cₚ*T_{c}*(1−(pₑ/p_{c})^{(k-1/k)}]^{0.5} (8)

in which

J=778 Joules constant

Cₚ molar specific heat at constant pressure

T_{c} combustion chamber temperature

p_{c} combustion chamber pressure

pₑ Exhaust chamber pressure

Then, the electrical power generated is given by;

\dot{W}ₑₗₑ=nπDN*q*Vⱼ/(60*ηₑ) (9)

where D is the diameter of the disc, upon which the micro thrusters are mounted,

N is the rpm (revolutions per minute) of the spinning disc

n is the number of thrusters

ηₑ Mechanical to electrical efficiency.

In equation 9 the rotational speed N of the disc, upon which the micro thrusters are mounted, needs to be selected. From standard text books the propulsive efficiency of a moving thrust engine is given by,

$${η}_{p} = \frac{2 * {V}_{mT}}{( {V}_{mT} + {V}_{j} )} \qquad ( 10 )$$

where

$${V}_{mT} = \frac{π DN}{60}$$

is the peripheral velocity of the disc and the thruster

D is the diameter of said disc

For optimum propulsive efficiency

V_{mT}=Vⱼ the exhaust gas velocity (12)

With this substitution, the required electrical energy rate is given by;

\dot{W}ₑ=nq Vⱼ²/ηₑ (13)

From equation 8, the jet velocity Vⱼ is almost predetermined by the allowable combustion chamber temperature. Then, mass flow is the only parameter that can be varied to provide excess power when needed. The total mass flow is a combination of fuel, air and steam. Again air to fuel ratio is fixed by the stoichiometric requirement for complete combustion. Then, steam to fuel ratio can be varied on demand to produce more power.

Let the total mass flow q be represented the mixture of fuel, air and steam

q=q_{f}(1+r_{af}+r_{sf}) (14)

where

q_{f} is the fuel mass

r_{af} air to fuel ratio, e.g. =20 for the natural gas

r_{sf} steam to fuel ratio, e.g. =0, 20, 30, 40 times fuel by weight.

These ratios will be used to compute partial pressures and mean temperature in the combustion chamber.

Let us now consider an example to demonstrate benefits the hybrid power system. The following data was used:

| | | |
|---|---|---|
| Vehicle weight = | 2000 | lbs. |
| Frontal area of the vehicle = | 10 | square feet |
| Aerodynamic drag coefficient = | 0.2 | |
| Rolling coefficient of the tires = | 0.05 | |
| Stoichiometric air to fuel ratio by weight = | 20 | |
| Combustion chamber pressure, p_{c} = | 160 | psi |
| Exit chamber pressure , pₑ = | 20 | psi |
| Natural gas flame temperature = | 3600 | deg. F |
| Road gradient = | 5 | percent |
| Number of micro-thrust engines = | 2 | |
| Overall mechanical efficiency = | 0.85 | |

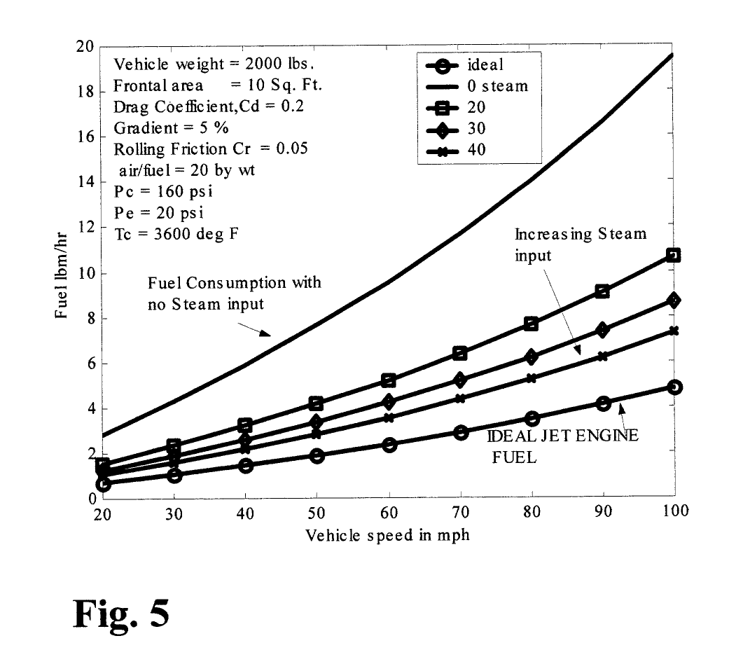

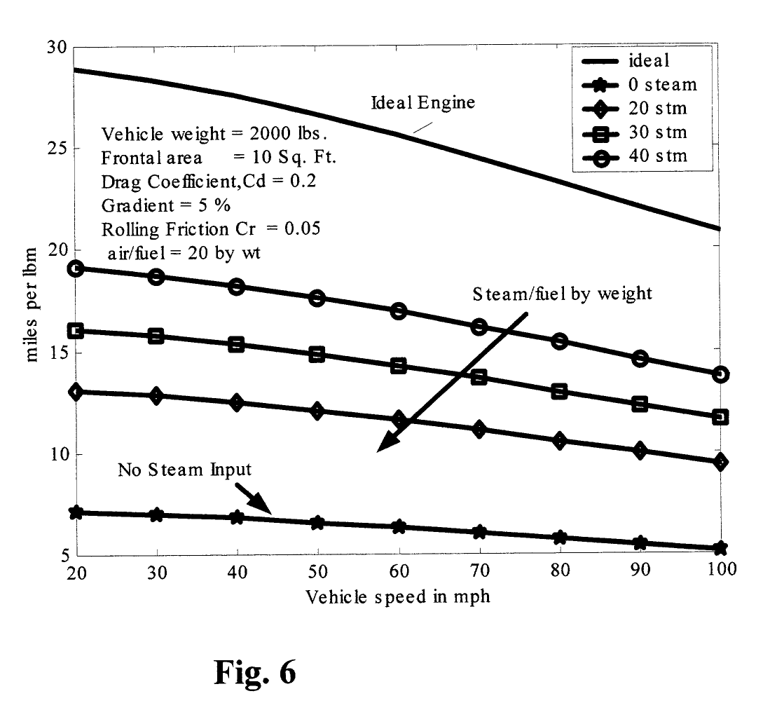

Omitting the acceleration requirement, the electric vehicle power requirement and fuel performance was computed for various amount of steam input. Air to fuel ratio was held constant. The computed results are presented in FIGS. 5-8. The bottom curve in FIG. 5 represents the amount of fuel required by an ideal engine at various vehicle speeds. An ideal engine is one, which requires just enough fuel to releases heat energy to compensate for the vehicle losses. The top curve in FIG. 5 shows the amount of fuel consumed by said engines of the present invention without addition of steam. The intermediate curves denote the fuel consumption with the addition of steam. As the steam to fuel ratio increases the fuel consumption decreases. Another vivid demonstration in terms of miles per pound of fuel mass is depicted in FIG. 6. In a worst scenario, the present method offers 6 miles per lb of natural gas at 100 miles an hour vehicle speed.

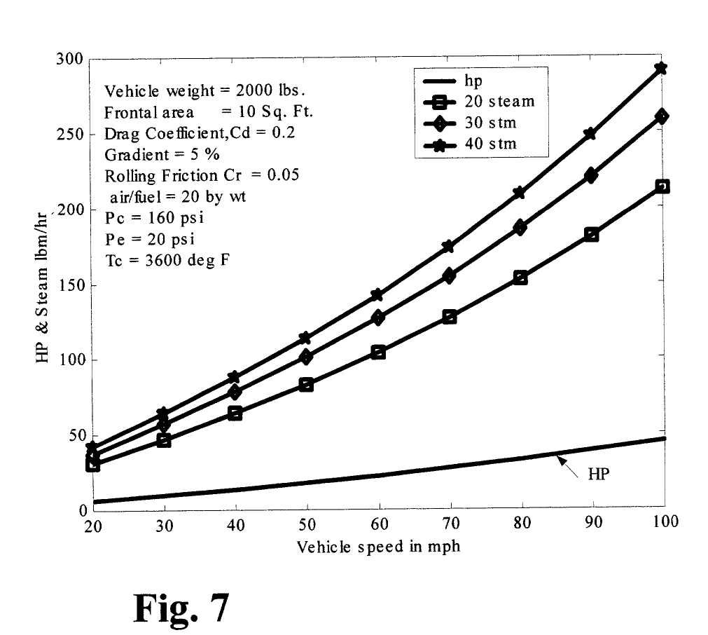

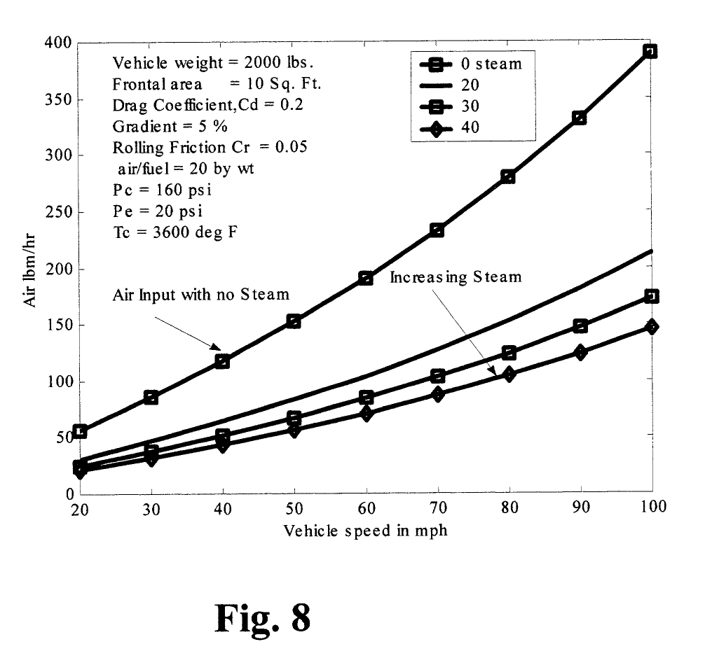

In FIG. 7 the bottom curve shows the horsepower required for the normal driving condition at various vehicle speeds. The other three curves show the amount of steam input having steam to fuel ratios of 20, 30 and 40 by weight. FIG. 8 shows the amount of air needed with and without steam input.

From the foregoing, consider some of the advantages of the proposed hybrid power system for an electric vehicle over the known hybrid electric vehicles:

1. Uses a single rotating platform, hence it is simple to manufacture and maintain,

2. It is a lightweight engine and costs less,

3. fuel is used for normal driving conditions,

4. natural gas produces more than 11 percent of steam which will be recycled and reheated while cooling the combustion chamber

5. acceleration and uphill drive conditions steam will be used instead of fuel,

6. Use of steam reduces fuel consumption,

7. Liquid nitrogen could be used as the source energy to expand through the nozzle,

8. Compressed air could be used as the another media of working fluid/fuel,

9. Any fossil fuel could also be used as the working energy source

It should be understood that the foregoing description is only illustrative of the invention. Various alternatives and modifications can be devised by those skilled in the art without departing from the invention. Accordingly, the present invention is intended to embrace all such alternatives, modifications and variances, which fall within the scope of the appended claims.

What is claimed is:

1. A hybrid electric vehicle having at least one electric motor drivingly connected to a pair of wheels and one electric generator driven by a hybrid power system comprising:
(a) a hybrid power generating system having plurality of micro-thrust engines mounted on the periphery of a spinning disc rotatably housed inside a supporting framework;
(b) a deep cycle battery and a power electronic system for storing electrical energy;
(c) an electric generator coupled to said hybrid power system;
(d) an active control system responsive to command signals that management fuel flow or steam flow, and electrical power flow either from said battery source and/or said generator during acceleration and uphill or normal driving conditions;
thereby providing fuel efficient and environmentally friendly transportation means.

2. A hybrid electric vehicle of claim 1, wherein regeneratively produced high enthalpy steam injected into said combustion chamber and expanded through said nozzle produces extra power needed during acceleration and uphill climbing conditions, thereby requiring no additional fuel input.

3. A hybrid electric vehicle of claim 1, wherein alternate working fluids such as Compressed air or liquid nitrogen or any fossil fuel in liquid or gaseous form can be used in said micro thruster to produce torque and in turn electric power.

4. A hybrid electric vehicle of claim 1, wherein said outer nozzle having means to generate plurality of counter rotating vortices could help to suppress jet noise.

5. A hybrid electric vehicle of claim 1, wherein a means to convey fuel and steam from a stationary platform to a rotating frame is provided by means of coaxial conduits using centrifugal means to draw fluids from stationary chamber to a rotating chamber.
